(19) United States
(12) Patent Application Publication
(10) Pub. No.: US 2004/0224144 A1
(43) Pub. Date: Nov. 11, 2004

(54) Humidity control with solid support

(76) Inventors: Albert L. Saari, Plymouth, MN (US); Robert L. Esse, Monticello, MN (US)

Correspondence Address: Angenehm Law Firm. Ltd., P.O. Box 48755, Coon Rapids, MN, 55448-0755, US

(21) Appl. No.: 10/435,523

(22) Filed: May 9, 2003

(51) Int. Cl. B32B 3/26

(52) U.S. Cl. 428/316.6; 428/317.9; 428/131; 428/155; 428/174; 428/71; 428/76

(57) ABSTRACT

A humidity regulation product, including a constant humidity filling, the filling being thickened from 500 centipoise to a non-flowing gel; an open cell foam being adapted to absorb filling thickened, the foam supporting the thickened constant humidity filling; and a holder, the open celled foam being disposed in the holder and a method of preparing a humidity regulation product, comprising the steps of: immersing open cell foam in a constant humidity filling; and treating the open cell foam with heat and pressure, wherein the filling is heated to a temperature between ambient temperature and the pressure adjusted boiling, point of the filling.

### FIELD OF THE INVENTION

The present invention relates to humidity regulators and more particularly portable humidity regulators.

### BACKGROUND OF THE INVENTION

Humidity regulators have been known for many years. Perhaps one of the earliest humidity regulators was simply a pan of water setting on a stove or heater. The pan was repeatedly re-filled with water as the heat from the stove or heater evaporated the water. The water vapor raised the humidity in an environment of low moisture.

It is well recognized that during cold weather, particularly in the Northern climes, the indoor moisture content may often be very low. This low humidity causes damage. For example, the drying out of pharmaceuticals resulting in degradation of the pharmaceuticals. The pharmaceutical would become dried out, e.g., dehydrated, which degrades the effectiveness of the pharmaceutical.

Over the years, sophistication has developed in humidity regulators. Homes today often include a humidifier that is associated with the central furnace or heating system. Water is automatically fed into the humidifier. The water is exposed to warm moving air which picks up the moisture, carrying the water vapor throughout the home.

Electronic controlled humidity regulators are very effective, but expensive and not generally portable and require substantial maintenance for good performance. Other humidity controlling devices as either humidifiers or desiccants. Humidifiers add moisture to the environment whether it is necessary or not, and thus tend to produce environments approaching 100% relative humidity. Desiccants have the opposite effect, removing moisture from the environment until the relative humidity is near 0%. A few types such as treated silicates or clays control the humidity in a relatively narrow range, but suffer from expense and or low capacity. These are not suited for large volumes such as rooms or buildings.

In other instances environments may contain an excess amount of water vapor. Such a condition is typically confronted in the below ground level portion of the house, typically referred to as a basement. If the basement is located in a soil environment that contains high moisture, the moisture may move through the walls, e.g., concrete, of the basement raising the moisture content in the basement air to an unacceptably high level. Devices have been designed to lower the moisture content; such devices are commonly referred to as dehumidifiers. These devices often work on a principle of refrigeration. The devices include a coil, perhaps tubular coils, through which a compressible fluid is passed. When the fluid is permitted to expand, the fluid rapidly lowers the temperature of the tubing. As moist air is passed over the tubing, condensation takes place on the tubing forming water which drops down into a removable pan. Periodically, the operator removes and empties the pan. All too often, the dehumidifier is forgotten, the pan over flows onto the floor and the water then evaporates, again raising the humidity.

Humidifying devices and dehumidifying devices of the type just described are generally not suitable for use in small containers. The described humidifying devices take up a substantial amount of space and simply will not fit within a small container. These devices have been in the form of desiccants. The desiccants do not maintain the elevated humidity that is needed to maintain the quality of the pharmaceutical. There have also been suggestions that the containers be kept in large cases in which the humidity is controlled. Large cases often are not suitable since they are not portable and cannot be easily carried with the person, for example during the work day.

One is confronted with two alternatives. One may leave the container without a humidifying device and risk the contents drying out to such an extent that the contents are degraded. Alternatively, one may place contents in a cabinet that has a humidifier device. The former results in lessened effectiveness in the contents. The latter is costly and generally not portable. The present invention overcomes these inherent problems of the prior art.

Highly advantageous portable humidifying devices have been developed for placement in containers as described in U.S. Pat. No. 5,936,178. These devices provide mechanism for controlling the relative humidity in a small container environment. These devices utilize an aqueous solution of a solute such as a salt or a sugar or other soluble compound that inherently creates a desired relative humidity in the air space adjacent to the humidity control mechanism.

The humidity regulator system described in U.S. Pat. No. 5,936,178 is fully satisfactory for applications requiring up to about 1 oz (28 g) of filling. In packets larger than about 1 oz., the filling tends to “sag” and the packet requires some restraint to be free standing. This is a shortcoming in applications that require greater capacity to remove to give off moisture such as in a desk humidor, musical instrument case, other large volumes as well as containers which are opened and closed frequently. In other applications, a pouch filled with the humidity controlling solution may require a physical support which adds cost or limits the location at which the device can be placed. A rigid regulator is preferable in an application such as a room or building humidity regulator system such as described in Honeywell U.S. Pat. No. 6,428,608.

The recent home/commercial air conditioning systems operate with higher temperature cooling coils because of a change in refrigerants or to save energy and operating costs. The consequence of this is that rooms tend to be close to relative humidities that support mold growth. Thus carpeting in contact with slabs, areas that have limited air circulation will have localized areas that are well above 75% Relative Humidity the general limit of significant mold growth. Thus, there is a significant increase in allergies attributable to mold in both residential and commercial buildings.

What is needed is a humidity control device suitable for maintaining a constant humidity at a predetermined level. The humidity control device should be structured in such a manner as to be suitable for enlarged environments such as a home or building and not merely a small area.

### DESCRIPTION OF THE DRAWINGS

FIG. 1 is a schematic view of how the present invention may be used to control the humidity within a building;

FIG. 2 is a partial cross sectional view of the array of panels; and

FIG. 3 is a perspective view showing the holder in phantom.

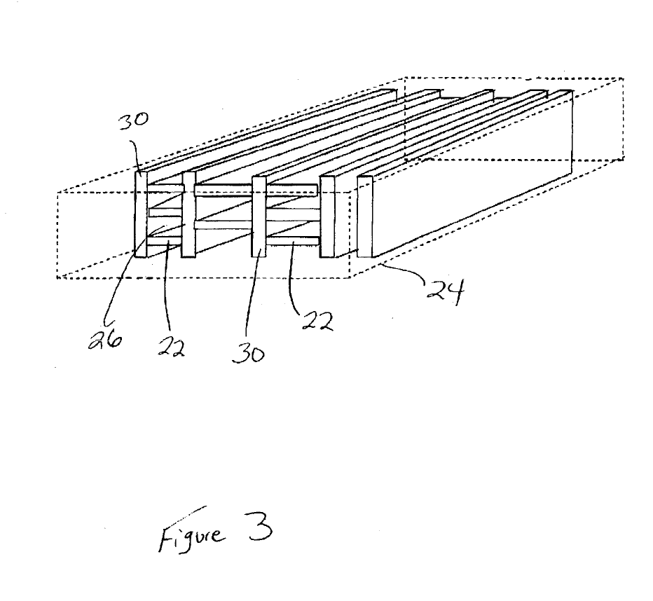

### SUMMARY OF THE INVENTION

The present inventive humidity regulation product includes a constant humidity filling and open celled foam and a holder. The filling may be thickened from 500 centipoise to a non-flowing gel. The open cell foam may be adapted to absorb filling thickened from 500 to 20,000 centipoise and the foam supports the thickened constant humidity filling. The open celled foam is preferably disposed in the holder.

The present invention also includes a method of preparing a humidity regulation product, including the steps of: immersing open cell foam in a constant humidity filling; and treating the open cell foam with heat and pressure, wherein the filling is heated to a temperature between ambient temperature and the pressure adjusted boiling point of the filling.

Advantageously, the present invention provides a chemical mechanism for controlling humidity on a large scale, such as a home or a building.

Also advantageously, the present invention includes a method for constructing and using a humidity control device for chemically controlling humidity on a large scale, such as in a home or building.

As yet a further advantage, the present invention controls humidity with chemicals to inhibit mold growth within a home or building.

Yet, the present invention provides a faster, perhaps 20-25% faster, humidification/dehumidification of air.

And yet another advantage, the present provides a structure for supporting humidity control gels, allowing the humidity control device to more accurately fit containers or be sized for larger applications.

As still yet another advantage, the present invention provides a chemical humidity control device that does not require an overwrap, allowing for higher water transfer rates.

Adavantageously, the present invention provides a self-supporting device with high capacity to condition the environment in chambers of more than a cubic foot of volume and/or those which are opened and closed frequently such as desk humidors, musical instrument cases, gun storage cases or vaults, etc.

### DETAILED DESCRIPTION OF THE PRESENT INVENTION

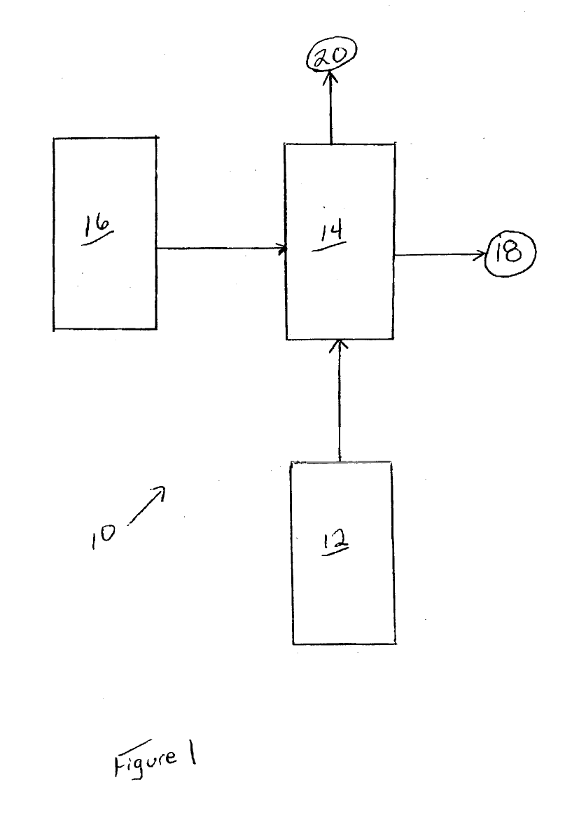

The present invention provides a humidity regulation product for use in an humidification control apparatus 10. FIG. 1 shows one mode of use, which is partially known in the art. The dehumidifier array 14 may be in airflow communication with an air conditioner 12, a building 20, a source of dry (perhaps heated) air source 16 and an exhaust area (preferably outside the building) 18. Conditioned air from the air conditioner 12, with perhaps a humidity level of 50%, enters the dehumidifier array 14. The dehumidifier array 14 may lower the humidity to 40% or lower and direct the conditioned air into the building after further reduction of the humidity. A dry air source 16, directs air into the dehumidfier array 14, when not interacting the air conditioner 12, to remove the accumulated moisture. The dry air source 14, using air from the attic, furnace or other source of dry air, may direct dry air into the dehumidfier array 14, wherein the dry air absorbs, e.g., removes, moisture from the array 14. The humidified air may then be directed outside the building as exhaust. Valves allow the dehumidifier array 14 to communicate alternatively with the dry air source 16 or the air conditioner 12. The present invention provides a structure for the chemical control of humidity within the array 14.

The product includes a constant humidity filling in a foam 22 and the foam 22 is disposed in a holder 24. The constant humidity filling may be thickened from 500 centipoise to a non-flowing gel and the filling solution includes a substantial amount of water in a fluid form as a saturated solution. Open cell foam 22 may be adapted to absorb or be impregnated with filling thickened from 500 to 20,000 centipoise such that the foam 22 supports the thickened constant humidity filling. The open celled foam 22 may be disposed in the holder 24.

The humidity regulator preferably includes an open-celled foam 22 impregnated with varying amounts of a saturated solution thickened with a suitable agent. The foam 22 may be one or more of a variety of shapes including a cube, rectangular block, a polygon block such as a pyramid, cylinder, tube, spheroid, tetrahedron, dodecahedron, and the like. It may be small (microscopic) or as large as is convenient to process keeping in mind that the rate of impregnation is measurably diminished as the dimensions exceed ¼ inch in the smallest dimension. This value of ⅓ inch applies to immersion in hot solution at atmospheric pressure. Under the pressure and release method, the dimension is on the order of about 1 inch before measurable reduction in the rate of impregnation occurs.

The present invention 10 provides a humidity regulator 14 which may be impregnated with constant humidity fillings disclosed in U.S. Pat. No. 5,936,178. Fillings described in the patent are useable as disclosed. However, for most applications, the humidity controlling filling in this invention requires less of the expensive thickening agent than the previously disclosed fillings. For example, 0.3-0.4% of brine tolerant xanthan or hydroxypropylguar is adequate for most applications.

### Filling Solution

The solution of the present invention may be any suitable solute which may have a saturated solution at 20% solute in water (percent by weight of solute in weight of solution) as a preferred minimum and any solute that will provide a saturated solution at 75% of solute in water as a preferred maximum. When used in a building, each piece of foam 22 should hold 3 or more ounces of solute. Solutions outside of this range normally will be either too high humidity or have limited capacity to either provide moisture or take up moisture during the regulating process. The most preferred range is a solute that is saturated between 25 and 50% solute. However, for some applications, the maximum range of 5 to 95% solute may be utilitarian. Some solutes, such as the sugars, are relatively slow to crystallize, thus work at a much slower rate than do ionic compounds such as sodium chloride or other salts.

The saturated solution should have an excess of fine, crystalline solute so that it has the capacity to absorb moisture from the environment. This amount depends on the solubility of the solute as well as the amount of moisture the humidity controller needs to be capable of absorbing for the intended application.

The filling solution may contain a solute such as salt, sugar and the like. Several different anions and cations can be combined to produce the proper salt solutions to attain a desired humidity. The cations which may be used are: ammonium, sodium, potassium, calcium, magnesium, lithium, strontium, rubidium, cesium, barium, among many. Anions which may be used are: nitrate, nitrite, chloride, bromide, fluoride, iodide, carbonate, phosphate, sulfate, acetate, citrate, succinate and organic acids. For example, the solute may be a single salt such as sodium chloride, ammonium nitrate, potassium nitrate, a mixture of salts such as 1 part ammonium nitrate and 1 part potassium chloride, or a nonionic substance such as urea or sorbitol.

Alternatively any of various solutes, such as sugars, sugar alcohols, polybasic acids, and salts of polybasic acids may also be used to produce the proper solutions. Some of the sugars which may be used are sucrose, glucose, galactose, etc. Some of the sugar alcohols which may be used include sorbitol, xylitol, mannitol. Some of the polybasic acids which can be used are citric, maleic, malic, fumaric, succinic. The salts of the polybasic acids which are usable include potassium citrate, sodium malate, and sodium tartrate.

Other, less common compounds may be used for creating the solutions. A partial list includes: lead chlorate, lead perchlorate, manganese chloride, mercuric nitrate, silver nitrate, mercuric nitrate, potassium dichromate, potassium permanganate, sodium chromate, aluminum nitrate, ammonium chloride, ammonium dihydrogen phosphate, ammonium bisulfite, sodium bisulfate, barium bromide, cobalt sulfate, copper sulfate, copper nitrite, ferrous sulfate, caldium chloride, magnesium chloride, potassium carbonate, potassium chloride, sodium bromide, salts of organic acids, ferric bromide and the like.

A solution of sodium chloride will provide a relative humidity of 75.5%. If the humidity falls below 75%, the salt solution gives up water to form moisture in the environment until the environment reaches a relative humidity of 75.5% while salt crystallizes out of solution. On the other hand, if the moisture in the air in the container rises above 75.5% relative humidity, the salt solution will take up moisture from the environment lowering the relative humidity to 75.5%. In this case, some of the excess salt crystals are dissolved to maintain the regulating solution at 75.5% Some examples of humidities possible with single and mixtures of solutes are listed below. Some solutes that produce/maintain humidity levels greater than 90% include potassium sulfate at 97%, monopotassium phosphate at 94%, potassium nitrate at 92% and cesium iodide at 91%.

Some solutes that produce/maintain humidity levels between 80 and 89% include barium chloride at 88%, sucrose or potassium chloride at 84% and potassium bromide or ammonium sulfate at 81%.

Solutes that produce and maintain humidity levels between 70 and 79% are: ammonium chloride at 78%, sodium chloride at 75.5% and strontium chloride at 71%. Solutes for humidities between 60 and 69% are potassium iodide at 69%, sodium nitrite at 65% and potassium citrate at 62%.

Other humidities that are useful include sodium bromide at 58%, sodium dichromate at 55%, magnesium nitrate at 53%, potassium carbonate 45%, sodium iodide at 38%, calcium chloride at 33%, potassium acetate at 22% and lithium chloride at 11%.

Other solutes and combinations of solutes can be used to obtain a wide range of relative humidity such as equimolar portions of sodium chloride, potassium nitrite and sodium nitrite give a 31% solution and a equimolar solution of ammonium chloride and potassium nitrate has a relative humidity of 72%. All RH percentages are theoretical and actual values will vary. The expected variation tends to be+/−1%.

The humidity controlling agent of the present invention preferably is a saturated solution of a solute in water that may or may not be thickened with a suitable material. For example, a suitable humidity controlling filling may be prepared by adding 50 parts of sodium chloride crystals to 5 parts of brine tolerant xanthan gum and 1000 parts of water at 200° F. When the somewhat thickened solution is homogeneous, an additional 350 parts of sodium chloride crystals are added with stirring.

In addition to a solute, the filling may contain a thickening agent. The saturated solution is preferably thickened by a water dispersible, salt tolerant, polymeric material or a hydrocolloid or a polysaccharide or similar material that substantially increases the viscosity of the solvent and is compatible with high concentrations of solute. Additionally or alternatively, the gel forming material may be a vegetable gum or a hydrocolloid or suitable mixtures of alginate, modified alginate, xanthan, guar, cellulose derivitized with hydroxyl propylene and the like. The combination of hydrocolloid, salt and water provides a viscous fluid. The thickening agent desireably thickens the solute between 500 centipose and a non-flowing gel. Preferably the thickening agent thickens the solute between 5,000 and 15,000 centipose.

The salt solution of the present invention is preferably thickened with a vegetable gum or a product of fermentation. The gums or hydrocolloids must be suitable for use in the concentrated salt solutions employed. The preferred thickeners are propylene glycol alginate, propylene glycol guar and xanthan. Other usable thickeners include pectin, guar, gum Arabic, tragacanth and some starches. Some seaweed hydrocolloids such as carrageenan, alginate and synthetic gums such as carboxymethyl cellulose and propylene glycol cellulose, can be used, especially in combination with other hydrocolloids and biopolymers. Often synergistic combinations of water thickening agents are more effective than the sum of their parts. Since many of these gums are unstable thickeners for saturated salt solutions, care must be used to provide reliable seals to prevent loss of liquid solution.

Saturated solutions without thickeners can be used with this invention. However, non-thickened solutions tend to seep fluid with the aid of gravity. Thus, it is desirable to employ thickeners to mitigate the seepage problem, especially when the humidity regulating device described is subject to a series of hydration/dehydration cycles.

The preferred concentration of the gums in a filling is between 0.5 and 2% of the total solution. These give a viscosity from a minimum of about 2500 cps to a non-flowing gel. Such a viscosity is adequate to maintain a uniform suspension of excess solute during filling of the device with the solution, depending on the density and size of the solute particle. Generally, viscosities below 1500 cps will require constant agitation of the filling in order to assure uniform suspension of the excess solute. A thixotropic or shear thinning gel is preferred for manufacturing purposes. In some instances, the present invention may be suitable without the addition of a gum or any other type of thickening agent.

Other features can be added to the humidity controller when a particular application requires additional capability. For example, a fungicide or mold inhibitor may be important at humidities above 75% to extend shelf life of the regulator as well as the material being protected by the regulator. Salts that may be reactive can often be inactivated by adjusting the pH of the filling solution with a buffer system. The regulator may be enclosed in a substantially impermeable wrapper with a window covered by a screen, cloth or another permeable material. The enclosing case or pouch may incorporate an opening such as a door or “zipper” to permit replacement of the foam regulator.

Mention should be made in some examples of a need for buffering or controlling the pH of the gel. When nitrite or nitrate are used, these are rather strong oxidizing agents under even slightly acidic conditions. This problem can be rectified by adding 0.5 to 1% sodium citrate, potassium citrate or a similar strong alkali, sodium or potassium carbonate or less preferentially sodium hydroxide or potassium hydroxide, or a weak base salt which increases the pH and subsequently acts as an acid/base buffer. The organic salts are preferable because carbon dioxide is not produced, which can change the density of the filling in unpredictable ways during the processing.

Similarly, Ammonia will be given off of Ammonium salt solutions at pH of 6 or greater. This can be readily corrected or eliminated by adding sufficient acid such as citric to lower the pH to about 5.

### Foam

Foam is generally defined as a dispersion of gas in a continuous liquid or solid matrix. The foam 22, in the present invention, is an open celled foam in which gas is dispersed in a solid, continuous matrix, in which the gas cells communicate through openings in the matrix. In contrast, closed cell foams have little or no communication between gas cells. In this invention, the gas in the cells is replaced by a constant humidity solution of a solute in water, thereby maintaining a constant Relative Humidity in the closed environment into which the device is placed. Foam 22 is the preferred structure, although other forms of continuous matrixes with gas exchange between cells is expected to also be useful, e.g. felt, course layers of paper, fabric, etc.

Foam 22 is impregnated with the filling. The foam 22 may be any stable open-celled foam 22. One preferred type of foam 22 is the “wet foam” used by florists in making floral arrangements. Other suitable foams 22 include rigid open cell foam, fine grain urethane, melamine, silicone, polyimide, rubber, large cell and thick wall foam. The foam 22 should be impregnated between 5% and 100% of the total theoretical impregnation and preferably between 50% and 80% of the total theoretical impregnation. Openings 26 may be defined through the foam 22 to provide passage for air through the foam 22.

Open cell foams include polyurethane, melamine, silicone, polyimide and the like that have a cell structure where there are openings between the cells, thus can absorb fluids. In contrast, closed cell foams have cells that are largely intact and thus are resistant to absorbing fluids. These foams can be rigid, semi-rigid or soft/flexible depending on the application.

For example, where the humidity regulator is to bridge open spans where soft pouches would sag, a rigid foam would be preferred. If the humidity regulator would be applied to an uneven surface, a soft foam 22 would be preferred. If a humidity regulator would be subject to pressure, a more firm foam 22 would be the choice and conversely if the humidity regulator were not subject to pressure, any foam 22 could be employed. In applications where the foam 22 is subject to compression, it is preferable to incorporate some 50 to 60 percent of theoretical maximum of filling.

The preferred foam 22 is a fine grained, open-cell polyurethane material similar to that used by florists. Among other open-cell foams that may be used are melamine, silicone, polyimide, and the like. Typically these foams 22 will have a void to solid ratio of 95 to 99% and a bulk density of less than one pound per cubic foot and can take up 50 or more times their weight of water.

### Holder

The foam 22 filled with saturated solution may be positioned within a holder 24. The holder 24 may be a chamber, protective material wrapping, porous protective unit or other pouch. That is, the foam 22 may or may not have a substantially impermeable coating over a portion of the foam 22. Openings 28 may be defined in the holder 24 with the openings preferably being between 0.1 to 0.5 inches in diameter. The foam 22 may be joined to the holder 24 with brackets 30.

The rigid foam 22 can be covered with a film 32 similar to the films used in the pouches, ie., Hytrel on paper, or Hytrel on nonwoven polyester, or the like. In cases where slower MVTR are acceptable, films such as K-resin, polyvinyl or polyvinylidene, nylon, and the like, on paper or nonwoven synthetic fiber can be used to reduce the costs considerably. The rigid foam 22 can be employed without cover in situations where it will not be in the open where it can be accidentally touched as the foams 22 are relatively fragile. However, it is preferable to cover the foam 22 by a porous material such as “Tyvek” as the humidification/dehumidification rates are 10 to 20% more rapid than for the uncovered foam 22.

For instance, the foam 22 may be protectively wrapped with a film 32 that permits release of the water vapor. Typical films 32 that meet the requirements of the present invention 10 include food wrap films of polyvinylchloride, microfiberous polyethylene, oriented polystyrene, cellophane, polycarbonate, and the like that have a WVTR of 3 grams or more. Hytrel from DuPont is especially functional. Several other films 32 may be used. The following is a list of some possible materials from which such films 32 can be made: polyester, polyamides (including Nylon), polyurethane, ethylcellulose, cellulose acetate, polybutylene, polyethylene terphthalate, polyvinylidene, polyvinylfluoride and polyvinylalcohol. A variety of copolymers and laminates may also be used. Films 32 made with certain rubbers with suitable properties may also be employed.

The most suitable polymeric films 32 used to wrap the impregnated foam 22 of the present invention 10 include polystyrene, polyvinylidine chloride, cellophane, microporous polyethylene, microfiberous polyethylene, K-Resin (Phillips Petroleum), Hytrel (DuPont) among others. The pouch may also be constructed of a polymeric material such as thin films 32 of polyethylene (0.25 mil), polyvinylchloride (0.5 mil), polybutylenes (0.3 mil), polypropylene (0.25 mil), polycarbonate (0.5 mil), cellophane and the like which provide the porosity necessary for the movement of the water vapor adequate for the application and retention of liquid water. As a general matter, the thinner film 32 is preferred providing the strength of the film 32 is sufficient to avoid rupture during normal use.

Alternatively, the foam 22 filled with saturated solution may be wrapped in felted sheets such as paper which is suitable with fillings with a humidity below about 60%. Tyvek is an excellent overwrapping material for this purpose. Preferably the paper has RH (Relative Humidity) values of about 75 or less. Paper is suitable for applications with relative humidity values of about 75 or less.

The fine grained, firm, open celled foams 22 such as the florists foam, can be protected by a screen, or a plate with multiple openings (⅛ inch or larger), especially when the saturated salt solution is thickened.

Films 32 are characterized by moisture transfer rates. The preferred rate of moisture transfer in the films 32 of the present invention may be as low as 0.1 g per 100 square inches per 24 hours may be adequate if the chamber has very little if any permeation of moisture vapor through the walls of the environment container or if the humidity regulator has a very large surface area. In most applications, an MVTR of about 10 g per 100 sq. in is preferred.

### Water Vapor Transmission Rate

Water vapor is free to move into and out of the foam body 22, although this occurs at varying rates. The water vapor transmission rate (WVTR) is determined by the type of foam 22 as well as the type and thickness of the film 32 or felt in which the foam 22 is contained. The total transmission is also affected by the exposed area.

An important function is to get as much transmission of vapor as possible and practical because it is preferable to reestablish equilibrium in the environment, e.g., container in which the humidity is being controlled as quickly as possible. The higher the transmission rate, the better the performance in retaining the proper moisture level in the material being protected in the container 24.

Ideally, one would like to have a very large rate, i.e., 25+grams per 100 square inches per day. However, it has been found that undesirable seeping may occur with certain saturated solutions if the absorption transmission rate exceeds 15 grams per 100 square inches per day. Using a good firm gel inside of the foam 22 may mitigate this seepage problem significantly if not completely. Desorption rates can be much higher.

The preferred range of water vapor transmission rates should be on the order of 15 to 30 grams of water per 100 square inches per day for restoration of humidity. For applications in which restoration is infrequent, less expensive films 32 with lower WVTR values may be acceptable.

### Method of Preparation

The present invention further includes a method of preparing a humidity regulation product 10, including the steps of: immersing open cell foam 22 in a constant humidity filling; and treating the open cell foam 22 with heat and pressure, wherein the filling is heated to a temperature between ambient temperature and the pressure adjusted boiling point of the filling. The pressure may be between 3 and 12 PSI and the filling may be heated to a temperature between 180-205° F.

Any of various methods of impregnation may be used. For example, the foam 22 may be placed in a bath of saturated solution at an elevated temperature. This method is progressively more rapid and complete as the boiling point of the saturated solution is approached. Further, some thickening agents have a diminished ability to produce high viscosity at elevated temperatures, thus permitting more rapid and complete impregnation of the foam 22. Another method includes compression of the foam 22 followed by release of the foam 22 while submerged in the saturated solution. In a third method, the foam 22 is submerged in the filling solution and a vacuum is drawn on the container to remove the air from within the foam 22. When the vacuum is released, filling is drawn into the airless voids in the foam 22. A fourth method is similar to the previous method except that the foam 22 is submerged in the filling solution in an autoclave and heated to a temperature that will produce a pressure of 5 or more pounds per square inch upon which the pressure is released to allow filling to impregnate the foam 22. A further method includes forming the foam 22 in situ with the solids of the filling admixed with the foam precursors prior to extrusion.

Boiling may also be achieved via drawing a vacuum to the vapor point of the filling and once the air is removed from the foam 22 the vacuum may be released. In this process the foam 22 may be immersed in the filling before drawing the vacuum. The vacuum may be used in either the presence or absence of heat. The filling may be cooled to about 150° F. while the foam 22 is still immersed.

A suitable piece (or pieces) of foam 22 is submerged in hot filling solution for 1 to 5 minutes, removed, drained and excess surface filling on the surface should be removed by a suitable method. When cooled to about 100° F., the partially impregnated foam piece 22 is preferably wrapped in a suitable material such as a semipermeable film or Tyvek.

Employing the technique reported in Patent EP 0-348-840-A2, where the take up of saturated humectant solution is enhanced by addition of a detergent or other surfactant, addition of surfactant to a saturated salt solution does not materially increase the absorption into florist's foam.

A highly controllable method of impregnating an open cell foam 22 involves immersing the foam 22 in filling, applying a vacuum for a few seconds to draw air from the interior of the foam 22, then releasing the vacuum while the foam 22 is submerged. The temperature of the filling must be chosen such that the viscosity is adequately reduced yet be just below the boiling point of the filling at the reduced pressure.

Another alternate method would be to bury a foam 22 fully saturated with water in finely ground or crystalline salts and allow the ions to diffuse into the wet foam 22. Excess salt cannot be readily incorporated with this method. Furthermore, the method is very slow (days) and not suitable for large scale manufacture of these regulators.

Larger celled, flexible or resilient foams 22 such as household sponges, upholstery foam will take up saturated salt solutions readily, but the contents can be readily expressed by applying mechanical pressure. Fluid saturated salt solutions will spontaneously flow out of such sponges because the cell size is large, averaging less than 25 cells/inch. Preparation of a thickened saturated solution will generally prevent such loss, but mechanical pressure on the saturated foam 22 will express the thickened solutions as well. Such foams 22 will require a semi permeable film 32 over wrap for practical use.)

Once impregnated with filling, the treated foam 22 may be placed in a mesh protective unit preferably selected from the group of: polyethylene fibers, Tyvek, paper at RH values of about 75 or less, non-absorbent fiber cloth, semipermeable membrane/film, Hytrel, cellophane, and polyvinylchloride.

The amount of filling incorporated into a foam 22 needs to be varied, depending on application. In applications where localized pressure may “dimple” or crush a portion of the foam 22, the amount of filling should be in the range of 50 to 75% of the theoretical capacity of filling so that the filling remains in the foam 22 with minimal oozing. In applications expecting little chance of crushing can be filled to 90%+.

To determine the maximum capacity of a piece of foam 22, a rectangular piece should be weighed, then placed into room temperature water for a minute or so until it barely floats. The piece is then weighed. Foams will absorb 20 times (cellulose sponge) its weight of water; florists foam will absorb about 50 times its dry weight. This absorption times the density of the filling will give the expected maximum absorption of the particular foam.

### Panel Arrangement

The regulator, within or without a covering 32, may be placed into a case or carton 34 made from wood, cardboard, plastic, metal, or the like, with a plurality of small openings 28. In one preferred embodiment about 2 openings per square inch were oval in shape being approximately 1/16^{th} by ⅛^{th} inches. The openings may be provided adjacent to one another with sufficient adjacent wall structure to provide the strength and protection desired to prevent damage to the pouch. One preferred device according to the present invention containing up to 20% open area. The strength requirement and material is dictated by the application and the abuse to which the case may be subject.

In addition to the methods of attaching the humidity regulator disclosed in U.S. Pat. No. 5,936,178, the more rigid foam based regulator permits unique ways of securing the device in place in the container, which it is intended to maintain at a constant humidity. For example, a foam disk can be held in place by friction in a suitable depression molded or stamped into the lid of the container. The disc can be held in place by a coarse screen of a suitable salt resistant material such as plastics or corrosion resistant metal or a bracket made of wood.

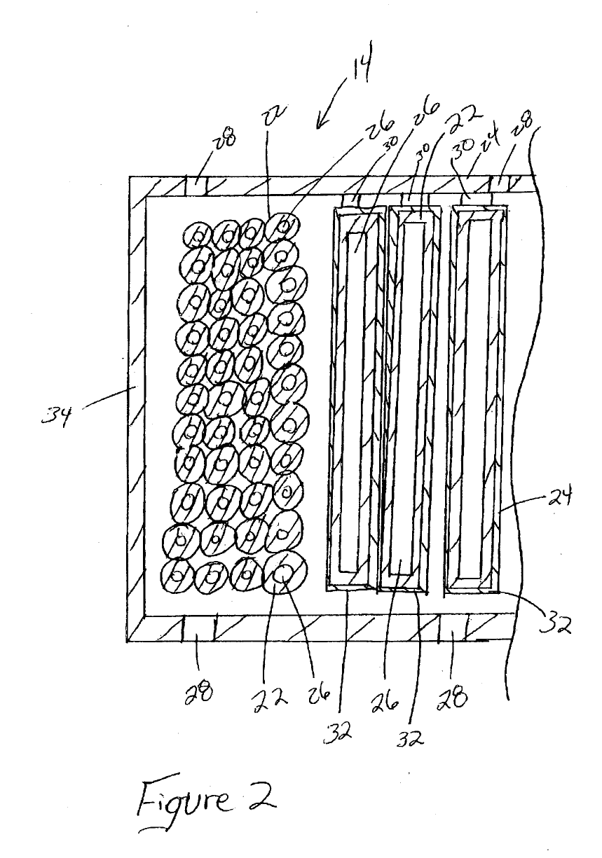

Openings 26 may be defined through the foam 22 allowing passage of air through the block of treated foam 22. Additionally or alternatively, the treated foam 22 may be arranged as an array of panels of foam 22 in a manner that permits air or gas to pass through the array, as shown in FIG. 2. The array of pouches of film 32 may be arranged in a manner that permits air or gas to pass through freely. Moisture in air passing through the foam 22 or through the array may be drawn out of the air to properly adjust the relative humidity. Absorbed water may be removed from the foam 22 with moderate (100 to 175° F.) temperature air or by passing dry air adjacent the foam 22, thereby raising the relative humidity to a desired level.

### EXAMPLE 1

An example of a foam preparation that needs only minimal protection at humidities of less than 75%:

Boiling water 250 ml

Flour salt 35 g

Brine tolerant Xanthan 5 g

Unflavored gelatin 10 g

Were mixed together and kept at a simmer (205° F.+) for about 3 minutes.

To this, Flour salt 135 g

Potassium sorbate 3 g were added with vigorous stirring with a wire whip and heated back to a slow boil (212° F.). Precut pieces of florist's foam, 3×3×¼ inches were immersed in the somewhat thickened saturated solution and the pot was removed from the heat. The foam was held under the surface while the contents cooled for about 5 minutes to approximately 175° F.

The pieces were wiped of excess thickened solution with a rubber spatula, placed on a rack to cool and surface dry. They absorbed approximately 45 times their weight of the solution and were “dry” to the touch, not sticky. These blocks of foam can be used without a film or other over wrap when the block is in an application where it is subject to transient (few hours—1-6 hours) humidities above the relative humidity of the solute (salt) employed.

A block of this foam, for example, could be used at the bottom of a hard sided carton of small cigars where the end to be lit rests on the block. The minimal salt/gum absorbed by the end of the cigar would be insignificant and unnoticeable to the smoker.

### EXAMPLE 2

### Vacuum

Urethane open-cell foam was cut into ⅝×2¾×3 inch blocks weighing about 1.25 g each. These blocks were placed into the base of a pressure cooker with ⅛ inch tubular spacers and covered with a filling consisting of 500 g sodium nitrite, 12 g brine tolerant Xanthan gum, 3 g potassium carbonate, 3 g sodium citrate and 500 ml water at 130° F. The filling was heated to about 150° F. to reduce the viscosity. A screen and weights were placed on top of the blocks to hold the blocks below the surface of the filling.

A vacuum of about 26 inches of mercury was drawn on the container, held for 5 minutes and released. The blocks were removed from the filling and excess adhering filling was scraped off with a rubber spatula being careful not to remove foam material.

These blocks took up approximately 46% of the theoretical amount of filling.

### EXAMPLE 3

### Vacuum

Another set of blocks described above were placed into a container and covered with filling consisting of 400 g of sodium chloride, 10 g of brine tolerant xanthan gum and 600 g of water at 140° F. This container was subjected to about 27 inches (Hg) of vacuum, held for 4 minutes and released. The blocks were scraped with a rubber spatula, set aside for an hour in a dry room (Relative Humidity approximately 40%).

These blocks took up approximately 52% of the theoretical amount of filling.

### EXAMPLE 4

### Heat & Pressure

A filling was prepared by combining 1400 g sodium chloride, 1000 g ammonium chloride, 27 g brine tolerant xanthan gum and 2500 g of water.

Three sizes of blocks of open—cell urethane foam were cut out: ½×½×2½ inches; ¾×¾×2½ inches; 1×1×4 ½ inches were placed in a pressure cooker. The filling was poured into the cooker and a screen with a weight was placed so that the foam pieces would remain submerged in the filling. The cooker was heated until the pressure reached 15 psi, held for 5 minutes and allowed to cool to about 120° F.

The pieces were removed, wiped with a rubber spatula and wiped with paper toweling. When weighed, all of the blocks incorporated at least 90 to 95% of the theoretical amount of the filling. There was no significant difference with the amount of filling incorporated between the 3 sizes of foam pieces.

### Operational Use

A series of observations of the operational characteristics of a new condominium on the Gulf Coast, Ala. in early September where the ambient temperature was in the low 80's and the relative humidity was 75 to 80%. The air temperature from an air conditioning vent was typically 68 to 72 F, and the relative humidity was 60 to 65%. A less allergenic output from the vent would be 65F and a relative humidity of 50 to 55%.

### EXAMPLE 5

To demonstrate the feasibility of further reducing the Relative Humidity from an air conditioner vent, a model was prepared from impregnated foam stripes. Fourteen (14) strips of an open cell rigid foam (florists wet foam) 3/16×¾×10 inches were impregnated with a thickened solution of calcium chloride, Relative Humidity=32%. These strips were arranged in an array consisting of 5 pairs held together with tooth picks, each pair being approximately 1 ¾×3/16 inches. These pairs were then separated by a single strip of the impregnated foam at their junction with toothpicks. The array was placed and centered into a cardboard box measuring 2×6×12 inches so that air flowing through the box would pass linearly through the box. A small blower moving about 0.5 cu ft per min was placed into an opening at one of the 2×6 ends and an opening was cut into the opposite end to accommodate a Temperature/Humidity data logger plus about 1 sq in to allow air to exhaust. Another logger was placed just below the blower to measure input air.

The box was weighed and placed into a chamber humidified with a potassium chloride solution. The box increased in weight by 34 g in 7.5 hours (4.5 g/hour). The box was then placed into a box dried with calcium chloride pellets. The box lost 38 g in 12 hours (3.2 g.hour).

### EXAMPLE 6

Two blocks of open cell foam measuring 3×4×10 inches were tunneled by either drilling ⅜ inch holes or slots measuring approximately 2×⅜ inches so that approximately 40% of the area of the 3×10 inch face was open. These blocks were impregnated with a thickened solution of calcium chloride, Relative Humidity=32%.

These were placed in a cardboard box measuring 3×12×12 inches. A small blower was placed in a tight fitting hole cut in the center of one of the 3×12 faces. A slot was cut in the opposite side to accommodate a Temperature/Humidity data logger. One of the impregnated blocks were placed about 1 inch from the face with the blower, the other about 1 inch behind the first one. A block of foam was placed to prevent air flow around the end of each block.

The unit was placed outside in the shade under warm, somewhat humid conditions. After about 7 hours, the unit was placed in a dry box to be restored overnight.

### EXAMPLE 7

The unit described in Example 6 was placed outside in a shady area on a still day. The input and outlet temperatures were measured with an electronic thermometer capable of +/−0.1° F. Measurements of the input and output temperatures were made after about 2 ¼ and 3 ¾ hours.

The results of this experiment are shown on Chart 3. After 2 ¼ hours, the outlet temperature was 1.9° F. higher and at 3 ¾ hours 1.3° F. higher than the input temperature. This is to be expected as reaction of water with crystalline calcium chloride is exothermic.

The unit reduced the relative humidity of the air approximately 15 percentage from about 55% to 40% removing 6.5 g of water per hour from the air. The temperature differential between the inlet and outlet temperatures is consistent with the amount of moisture absorbed by the unit.

In this model were scaled up for a moderate size house of 250 sq. ft., it would have to remove approximately 3 pounds of water from each total change of air in the house, lowering the relative humidity from 60% to 50%. Treating 4 to 5 changes of air will require an array of approximately one hundred pounds of impregnated foam.

### EXAMPLE 8

Pouches, 3×8 inches, made with 1.5 mil Hytrel (DuPont) film extruded on 24 lb paper, were filled with approximately 60 g each of thickened filling with a relative humidity of 32%. These were placed in a 2 ¾×8 ½×11 ¼ inch box in 5 layers set on a plastic screen separated with ¼ inch spacers. A blower and data loggers were attached as described in above examples 6 and 7.

The unit was placed outside on a cool, moist cloudy day for approximately 8 hours. After about 2 hours, the unit reduced the humidity from the input air from about 65% to about 35% at about 40° F.

Although the present invention has been described with reference to preferred embodiments, workers skilled in the art will recognize changes may be made in form and detail without departing from the spirit and scope of the invention.

I claim:

1. A humidity regulation product, including:
a constant humidity filling, the filling being thickened from 500 centipoise to a non-flowing gel;
an open cell foam being adapted to absorb filling thickened from 500 to 20,000 centipoise, the foam supporting the thickened constant humidity filling; and
a holder, the open celled foam being disposed in the holder.

2. The humidity regulation product of claim 1 wherein the filling is a salt solution.

3. The humidity regulation product of claim 2 wherein at least one cation is selected from the group consisting of ammonium, sodium, potassium, calcium, magnesium, lithium, rubidium, cesium, barium, and strontium.

4. The humidity regulation product of claim 2 wherein at least one anion is selected from the group consisting of: carbonate, chloride, bromide, fluoride, iodide, nitrate, nitrite, phosphate, sulfate, acetate, citrate, succinate and organic acids.

5. The humidity regulation product of claim 2 wherein the solute includes at least one member selected from the group consisting of: sodium chloride, ammonium nitrate, potassium nitrate, sucrose, glucose, urea, monosaccharide, crystalline organic acids, ammonium chloride, caldium chloride, magnesium chloride, potassium carbonate, potassium chloride, sodium bromide, salts of organic acids and disaccharide.

6. The humidity regulation product of claim 1 wherein the filling further comprises a thickening agent.

7. The humidity regulation product of claim 6 wherein the thickening agent is selected from the group consisting of: vegetable gum, including alginate, modified alginate, guar, cellulose derivitized with hydroxyl propylene, xanthan, a mixture of hydrocolloids suitable for high salt applications including chemically modified hydrocolloids and biopolymers.

8. The humidity regulation product of claim 1 wherein the foam is impregnated between 5 and 100% of the theoretical impregnation.

9. The humidity regulation product of claim 8 wherein the foam is impregnated between 50 and 80% of the theoretical impregnation.

10. The humidity regulation product of claim 1 wherein the constant humidity filling is thickened to from 5,000 to 15,000 centipoise at room temperature.

11. The humidity regulation product of claim 6 wherein the foam is at least one member selected from the group consisting of: rigid open cell foam, fine grain urethane, “florists foam”, melamine, silicone, polyimide, rubber, large cell, cellulose and thick wall foam.

12. The humidity regulation product of claim 1 further including:
openings defined through the foam allowing passage of air through the foam.

13. The humidity regulation product of claim 1 wherein the holder is a chamber.

14. The humidity regulation product of claim 1 wherein the holder is a protective material wrapping.

15. The humidity regulation product of claim 1 wherein the holder is a porous protective unit selected from the group consisting of:
polyethylene fibers, Tyvek, paper at RH values of about 75 or less, non-absorbent fiber cloth, semipermeable membrane, semipermeable film, Hytrel, cellophane, polyvinylchloride, polyester, and polypropylene.

16. The humidity regulation product of claim 1 further including:
openings defined in the holder, the openings being between 0.1 to 0.5 inches in diameter.

17. The humidity regulation product of claim 1 wherein the foam is joined to the holder with brackets.

18. The humidity regulation product of claim 1 further including:
an array of panels of foam arranged in a manner that permits air or gas to pass through the array.

19. The humidity regulation product of claim 18 further including:
passages defined through the array of panels with passage dimensions of 0.1 to 1.0 inches.

20. The humidity regulation product of claim 19 wherein the passage dimensions are between 0.1 and 0.25 inches.

21. A method of preparing a humidity regulation product, comprising the steps of:
immersing open cell foam in a constant humidity filling; and
treating the open cell foam with heat and pressure, wherein the filling is heated to a temperature between ambient temperature and the pressure adjusted boiling point of the filling.

22. The method of claim 21 wherein the pressure is at least 3 PSI.

23. The method of claim 21 wherein the filling is heated to a temperature between 180-205° F.

24. The method of claim 21 further comprising the steps of:
drawing a vacuum to the vapor point of the filling; and
releasing the vacuum.

25. The method of claim 24 further comprising the steps of:
immersing the foam in the filling before drawing the vacuum.

26. The method of claim 21 further including the step of:
cooling the immersed filling to about 150° F. while the foam is still immersed.

27. The method of claim 21 further including the step of:
placing the treated foam in a mesh protective unit selected from the group consisting of: polyethylene fibers, Tyvek, paper at RH values of about 75 or less, non-absorbent fiber cloth, semipermeable membrane/film, Hytrel, cellophane, and polyvinylchloride.

28. The method of claim 21 further comprising the step of:
defining openings through the foam allowing passage of air through the block of treated foam.

29. The method of claim 21 further comprising the step of:
arranging an array of panels of foam in a manner that permits air or gas to pass through the array.

30. The method of claim 21 further comprising he step of:
removing absorbed water with moderate (100 to 175° F.) temperature air.

31. The method of claim 29 further comprising the step of:
removing absorbed water by passing dry air adjacent the foam.

32. The method of claim 21 further comprising the step of:
arranging an array of pouches of film in a manner that permits air or gas to pass through freely.
